(19) United States
(12) Patent Application Publication
(10) Pub. No.: US 2026/0328906 A1
(43) Pub. Date: Oct. 22, 2026

(54) EXPERIMENTAL SYSTEM FOR JOINTLY AND SYNCHRONOUSLY MEASURING LASER MICRO-DOPPLER AND POLARIZATION CHARACTERISTICS OF SPACE TARGETS

(71) Applicant: Harbin Institute of Technology, Harbin (CN)

(72) Inventors: Zhen YANG, Harbin (CN); Kaiyuan GUI, Harbin (CN); Yong ZHANG, Harbin (CN); Jianlong ZHANG, Harbin (CN); Dan JIAO, Harbin (CN); Xinlei QV, Harbin (CN); Xin DA, Harbin (CN)

(21) Appl. No.: 19/701,042

(22) Filed: Jun. 8, 2026

(30) Foreign Application Priority Data
Jul. 8, 2025 (CN) 202510938024.X

(51) Int. Cl. G01S 7/48; G01S 7/481; G01S 7/4911; G01S 7/4912; G01S 7/499; G01S 17/58; G01S 17/89

(52) U.S. Cl. CPC G01S 7/4802; G01S 7/4814; G01S 7/4911; G01S 7/4917; G01S 7/499; G01S 17/58; G01S 17/89

(57) ABSTRACT

The present disclosure discloses an experimental system for jointly and synchronously measuring laser micro-Doppler and polarization characteristics of space targets. The experimental system comprises a light source module and a micro-Doppler-polarization module. The emitted light from the light source module is split by a fiber beam splitter for energy distribution, and then equally distributed into four channels through a fiber beam splitter; the micro-Doppler-polarization module adopts a coherent detection architecture, and heterodyne mixing is performed on the four local oscillator beams and the corresponding echo light of the polarization state, respectively, the system measures the intensities of each polarization component in the echo light in real time, while simultaneously obtaining the micro-Doppler frequency shift of the target motion.

### TECHNICAL FIELD

The present disclosure belongs to the application field of laser radar and relates to an experimental system for jointly and synchronously measuring laser micro-Doppler and polarization characteristics of space targets.

### BACKGROUND

With the continuous growth of human space activities, the number and variety of space targets have been steadily increasing, these include both operational and uncontrolled targets, such as satellites, spacecraft, debris, and explosion fragments. Achieving high-precision, real-time detection of various space targets has thus become a critical challenge in the advancement of space technology. As a fundamental physical quantity describing the interaction between light and matter, optical polarization characteristics can reveal differences in material optical constants, surface roughness, coating properties, and more. Therefore, leveraging the polarization characteristics of targets offers a new dimension for the detection, classification, and identification of space targets.

The detection technique based on the laser micro-Doppler effect, known for its high resolution and high detection sensitivity, has been widely used to measure the motion and geometric parameters of space targets. As a key parameter to describe the spatial orientation of the target, the attitude angle not only determines the angle of the polarized light incident on the target surface, but also affects the change of the polarization characteristics of the echo light. By accurately estimating the attitude angle of the target, the contribution of the inherent properties of the material to the depolarization characteristics is separated, thereby obtaining the law of “incident attitude angle-degree of depolarization” of different materials, which provides a new method for accurate resolution and recognition of space targets and improves the accuracy of detection technology.

In previous studies, however, micro-Doppler and polarization measurements are typically conducted independently at different times. This approach suffers from two major drawbacks. On the one hand, time-separated measurements result in the micro-Doppler and polarization parameters being acquired at different time points, making it impossible to align the physical states under identical observational conditions, this hinders rapid detection and accurate response to targets moving at high speeds. On the other hand, applying either the micro-Doppler effect or polarization characteristics in isolation fails to provide a comprehensive and accurate means of target detection and recognition, thereby reducing the reliability of such processes.

### SUMMARY

To solve the problems existing in background technology, the present disclosure provides an experimental system for jointly and synchronously measuring laser micro-Doppler and polarization characteristics of space targets. The system measures an intensity of each polarization component in an echo light in real time and obtains a micro-Doppler frequency shift of a target motion. An attitude angle and a degree of depolarization of the target are calculated by an algorithm. The degree of depolarization collected under different materials and multiple incident attitude angles is statistically analyzed, and an “incident attitude angle-degree of depolarization” mapping database is established. It can provide a new dimension for unknown space target detection and promote a development of space target detection technology to a more refined and intelligent direction.

An objective of the present disclosure is realized through the following technical schemes:

An experimental system for jointly and synchronously measuring laser micro-Doppler and polarization characteristics of space targets, including a light source module, a micro-Doppler-polarization module, and a host computer, where:

An emitted light from the light source module is split by a 1:9 fiber beam splitter for energy distribution. A local oscillator beam with a 10% power ratio is first modulated by an acousto-optic modulator with an 80 MHz fundamental frequency, and then equally distributed into four channels through a 1:1:1:1 fiber beam splitter, designated as local oscillator beam 1, local oscillator beam 2, local oscillator beam 3, and local oscillator beam 4;
the micro-Doppler-polarization module employs two polarization beam splitters to decouple the echo light into four linearly polarized beams with equal energy and polarization states of 0°, 90°, 45°, and 135°, respectively, designated as echo light 1, echo light 2, echo light 3, and echo light 4;
the micro-Doppler-polarization module adopts a coherent detection architecture, and heterodyne mixing is performed on the four local oscillator beams and a corresponding echo light of the polarization state, respectively. After a photoelectric conversion is completed by photodetectors, a real-time signal acquisition is realized by a high-speed data acquisition card, and a collected signal is transmitted to the host computer by the high-speed data acquisition card;
the host computer calculates an energy corresponding to each polarization state after receiving four mixing signals, and then obtains a degree of depolarization of a target echo light. Meanwhile, four mixing signals are regarded as four laser micro-Doppler signals. Then, through digital filtering, time-frequency analysis, and parameter calculation steps, the incident attitude angle of the target is obtained, and a synchronous real-time measurement of the micro-Doppler and polarization characteristics of the target is realized. On this basis, the degrees of depolarization collected under different materials and various incident attitude angles are statistically analyzed, and the “incident attitude angle-degree of depolarization” mapping database is established, thereby realizing a joint application of micro-Doppler and polarization characteristics in the field of space target detection and recognition;
the degree of depolarization D is expressed as:

D=1−P

$$P = \frac{\sqrt{{S}_{1}^{2} + {S}_{2}^{2}}}{{S}_{0}}$$

In the formula, P is the degree of polarization, S₀ is a total intensity of light wave, S₁ is an intensity difference between linearly polarized beams in x and y directions, and S₂ is an intensity difference between linearly polarized beams in 45° and 135° directions;
an extraction formula of an incident attitude angle α is:

$$α = arcsin ( \frac{\vert {f}_{max} λ \vert}{4 \vert AB \vert π {f}_{s}} )$$

In the formula, |AB| is a distance from a vertex of a cube target to a center, |AB|=\sqrt{2}/2L, L is a side length of the cube target, fₘₐₓ is a maximum frequency shift of the micro-Doppler, λ is a wavelength of an emitted laser, and fₛ is a known spin frequency of the target.

Compared with existing technologies, the present disclosure has the following advantages:

1, The present disclosure enables real-time measurement of the intensity of each polarization component in the echo light while simultaneously obtaining the micro-Doppler frequency shift of the target motion, through algorithmic processing, it synchronously calculates both the attitude angle and the degree of depolarization of the target.

2, The present disclosure allows for statistical analysis of the degree of depolarization acquired from different materials and various incident attitude angles, thereby establishing the “incident attitude angle-degree of depolarization” mapping database. By integrating micro-Doppler and polarization characteristics, it forms a multi-dimensional method for target detection, recognition, and classification, providing a new dimension for a detection of unknown space targets.

### BRIEF DESCRIPTION OF THE DRAWINGS

FIG. 1 is a schematic diagram of the laser micro-Doppler detection principle for space targets;

FIG. 2 is a schematic diagram of the experimental system for joint micro-Doppler and polarization detection;

FIG. 3 is a graph showing the degree of depolarization of artificial composite materials compared with other materials;

FIG. 4 is a time-frequency spectrum of the synchronously measured micro-Doppler signal.

### DETAILED DESCRIPTION

The technical solution of the present disclosure is further described below with reference to the drawings. However, the disclosure is not limited to the described embodiments. Any modifications or equivalent substitutions made to the technical solution of the present disclosure without departing from the spirit and scope thereof shall fall within the protection scope of the present disclosure.

The present disclosure provides an experimental system for jointly and synchronously measuring laser micro-Doppler and polarization characteristics of space targets. The system includes a light source module, a micro-Doppler-polarization module, a target module, and a host computer, where:

The light source module employs a fiber laser with the wavelength of 1064 nm, emits polarized light with a power of 100 mW, and the spot diameter is 2 cm after collimation.

The micro-Doppler-polarization module synchronously measures multiple polarization components in the echo light. Each polarization component may be regarded as a micro-Doppler signal to obtain polarization characteristics and micro-Doppler characteristics in real time.

The target module includes natural biological materials and artificial composite materials. The natural biological materials cover various types of bird feathers, while the artificial composite materials are primarily those commonly used for space targets, as well as paper, wood boards, and the like.

The emitted light from the light source module is split by a 1:9 fiber beam splitter for energy distribution, the local oscillator beam with a 10% power ratio is first modulated by an acousto-optic modulator with an 80 MHz fundamental frequency, and then equally distributed into four channels through a 1:1:1:1 fiber beam splitter, designated as local oscillator beam 1, local oscillator beam 2, local oscillator beam 3, and local oscillator beam 4. The micro-Doppler-polarization module employs two polarization beam splitters to decouple the echo light into four linearly polarized beams with equal energy and polarization states of 0°, 90°, 45°, and 135°, respectively, designated as echo light 1, echo light 2, echo light 3, and echo light 4. The micro-doppler-polarization module adopts a coherent detection architecture, and heterodyne mixing is performed on the four local oscillator beams and a corresponding echo light of the polarization state, respectively. After the photoelectric conversion is completed by photodetectors, a real-time signal acquisition is realized by a high-speed data acquisition card, and the collected signal is transmitted to the host computer by the high-speed data acquisition card. The host computer calculates the energy corresponding to each polarization state after receiving four mixing signals, and then obtains the degree of depolarization of the target echo light. Meanwhile, four mixing signals are regarded as four laser micro-Doppler signals. Then, through digital filtering, time-frequency analysis, and parameter calculation, the characteristic parameters of the target are obtained, and the most concerned parameter, the incident attitude angle, is selected. In this way, the synchronous real-time measurement of the micro-Doppler and polarization characteristics of the target is realized. On this basis, the degree of depolarization collected under different materials and various incident attitude angles is statistically analyzed, and the mapping database of “incident attitude angle-degree of depolarization” is established, thereby realizing the joint application of micro-Doppler and polarization characteristics in the field of space target detection and recognition.

In this present disclosure, the measurement method of polarization characteristics is as follows:

The Stokes vector is the most commonly used method for describing the polarization state of light waves, and the Stokes vector may accurately and concisely represent fully polarized light, partially polarized light, and natural light.

$$\frac{〈 {E}_{x}^{2} ( t ) 〉}{{E}_{o x}^{2}} + \frac{〈 {E}_{y}^{2} ( t ) 〉}{{E}_{o y}^{2}} - \frac{2 〈 {E}_{x} ( t ) {E}_{y} ( t ) 〉}{{E}_{o x} {E}_{o y}} cos δ = {sin}^{2} δ \qquad ( 1 )$$

In the formula, Eₒₓ and E_{oy} are the amplitudes of the electric vector in the x-direction and the y-direction, respectively. [symbol] ⋅ [symbol] denotes time averaging, and δ denotes the phase difference between the x-direction component and the y-direction component of the electric vector.

It can be obtained that:

$$( {E}_{x}^{2} ( t ) 〉 = \frac{1}{2} {E}_{o x}^{2} \qquad ( 2 )$$

$$〈 {E}_{y}^{2} ( t ) 〉 = \frac{1}{2} {E}_{o y}^{2} \qquad ( 3 )$$

$$〈 {E}_{x} ( t ) {E}_{y} ( t ) 〉 = \frac{1}{2} {E}_{o x} {E}_{o y} cos δ \qquad ( 4 )$$

The finally result is:

$$( {E}_{o x}^{2} + {E}_{o y}^{2} ) + ( {E}_{o x}^{2} - {E}_{o y}^{2} ) - {( 2 {E}_{o x} {E}_{o y} cos δ )}^{2} = {( 2 {E}_{o x} {E}_{o y} sin δ )}^{2} \qquad ( 5 )$$

Four Stokes parameters can be obtained from the above formula:

$${S}_{0} = {E}_{o x}^{2} + {E}_{o y}^{2} \qquad ( 6 )$$

$${S}_{1} = {E}_{o x}^{2} - {E}_{o y}^{2}$$

$${S}_{2} = 2 {E}_{o x} {E}_{o y} cos δ$$

$${S}_{3} = 2 {E}_{o x} {E}_{o y} sin δ$$

In the formula, S₀ is the total intensity of the light wave, S₁ is the intensity difference between linearly polarized beams in x and y directions, S₂ is the intensity difference between linearly polarized beams in the 450 and 135° directions, and S₃ is the intensity difference between right-handed and left-handed circularly polarized lights.

Since the circularly polarized component of most polarized light is negligible within the detection range of typical instruments, S₃=0 is taken in polarization detection. The degree of polarization P represents the proportion of the linearly polarized beam component in the total intensity of the light wave, can be expressed using the Stokes vector elements as follows:

$$P = \frac{\sqrt{{S}_{1}^{2} + {S}_{2}^{2}}}{{S}_{0}} \qquad ( 7 )$$

The degree of depolarization D can be expressed as:

D=1−P (8)

In this present disclosure, the cube is used as the detection target to analyze the micro-Doppler characteristics of the space target.

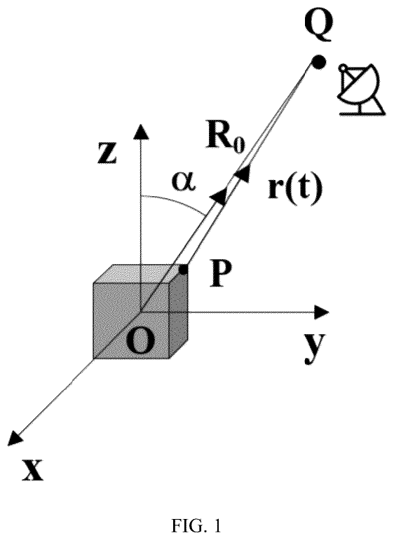

As shown in FIG. 1, the side length of the cube is denoted as L, the intersection point between the centroid O and the upper bottom surface is A, a vertex on the upper bottom surface is denoted as B, the attitude angle is α, and the line-of-sight vector of the lidar is \vec{n}=[0, sin a, cos α], the angle between the vector \vec{oB} and \vec{n} is denoted as γ, and the distance from the target to the lidar is denoted as R.

The range modulus from vertex B to the lidar is:

$$r ( t ) = \sqrt{{\vert oB \vert}^{2} + {R}_{0}^{2} - 2 \vert oB \vert {R}_{0} cos γ} \qquad ( 9 )$$

Generally speaking, the size of the target is much smaller than the distance from the target to the radar, which further yields:

r(t)=R₀−\vec{oB}·\vec{n} (10)

The cube vertex B spins around the z-axis, and the position vector \vec{oB} from the centroid O at each instant is:

\vec{oB}=(|AB|cos 2πfₛt,|AB|sin 2πfₛt,|OA|)^{T} (11)

The micro-Doppler frequency can be obtained as:

$$f = \frac{2}{λ} \frac{dr ( t )}{dt} = ( \frac{4}{λ} \vert AB \vert π {f}_{s} sin α ) cos 2 π {f}_{s} t \qquad ( 12 )$$

Therefore, the maximum frequency shift of micro-Doppler can be obtained as follows:

$$\vert {f}_{max} \vert = \frac{4}{λ} \vert AB \vert π {f}_{s} sin α \qquad ( 13 )$$

When the side length L of the cube target is known, |AB|=−\sqrt{2}/2L is also a known quantity. If the spin frequency of the target is known in advance, Formula (13) contains only one unknown parameter α.

Finally, the extraction formula of the attitude angle is:

$$α = arcsin ( \frac{\vert {f}_{max} λ \vert}{4 \vert AB \vert π {f}_{s}} ) \qquad ( 14 )$$

Therefore, after obtaining the echo signal of the space target by lidar at an unknown attitude angle, the echo signal is processed by a short-time Fourier transform to obtain the corresponding time-frequency spectrum. Based on the edge peak of the time-frequency spectrum, when the side length and spin frequency of the target are known, the attitude angle can be inversely solved according to Formula (14), thereby obtaining the micro-Doppler characteristics of the target.

In this present disclosure, the relationship between polarization characteristics and laser micro-Doppler effect is as follows: According to the analysis of polarization principles, when the polarization state of incident light is constant, and the transmission medium remains unchanged, the degree of depolarization of the target is mainly affected by its material properties and incident attitude angle. Based on the micro-Doppler effect of the space target, the characteristic parameters of the target are calculated according to the time-frequency spectrum of the micro-Doppler signal, including the attitude angle of the target. When the target attitude angle is known, the polarization characteristics of different targets are obtained by measuring the degree of depolarization of different targets, which provides a new data dimension for subsequent target detection, recognition, and classification.

### Embodiment

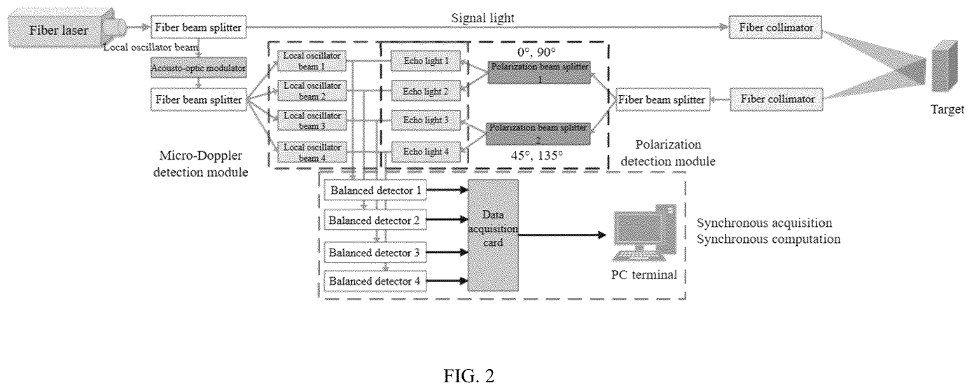

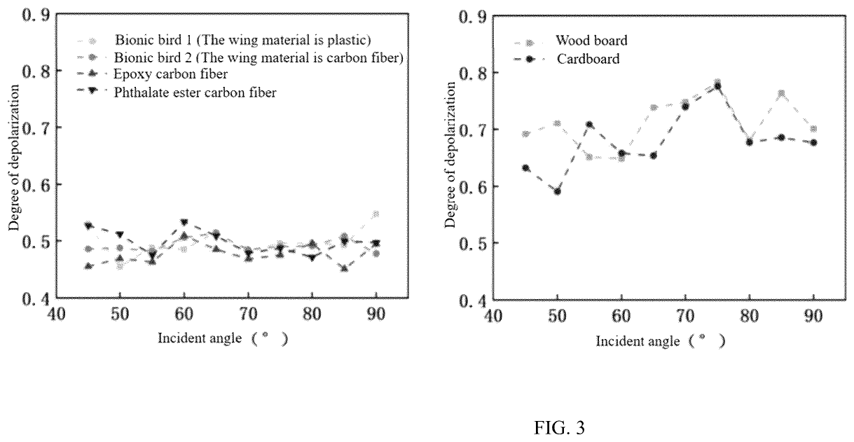

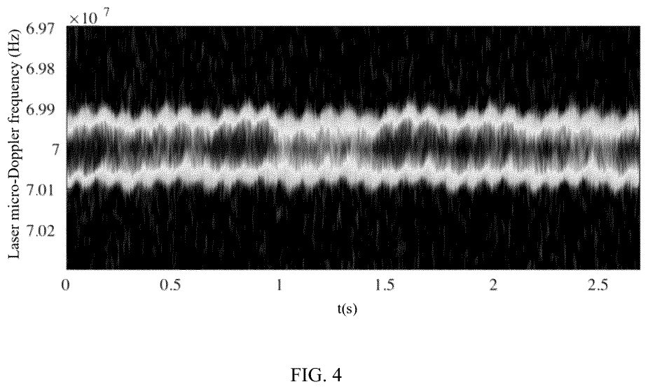

In this embodiment, the experimental setup of the synchronized joint detection system for micro-Doppler and polarization measurements is illustrated in FIG. 2. The system uses a 1064 nm fiber laser as the seed source. The output optical signal is split by a fiber beam splitter for energy distribution, generating two optical paths. Among them, the local oscillator beam with 10% power ratio is first frequency-modulated by an acousto-optic modulator with a 70 MHz fundamental frequency, and then equally distributed into four channels via a 1:1:1:1 fiber beam splitter, designated as local oscillator beam 1, local oscillator beam 2, local oscillator beam 3, and local oscillator beam 4. Meanwhile, the signal light with 90% power ratio is power-amplified, projected onto the target area through the transmitter, and its reflected echo is received. This echo signal is decoupled by a polarization beam splitter into four optical paths of equal energy, corresponding to linearly polarized beams with polarization states of 0°, 90°, 45°, and 135°, designated as echo light 1, echo light 2, echo light 3, and echo light 4. The system adopts the coherent detection architecture. The four local oscillator beams are respectively coupled with the corresponding echo light of the polarization state into fiber couplers for heterodyne mixing. The mixed outputs are converted from optical to electrical signals via photodetectors, followed by real-time signal acquisition using a high-speed data acquisition card. The degree of depolarization of the echo signal is then calculated according to Formula (8). FIG. 3 presents the polarization response characteristics of artificial composite materials (such as epoxy carbon fiber, polyester carbon fiber, and plastic), as well as paper and wood boards, revealing the essential differences in their optical field modulation mechanisms. Specifically, within the incident angle range of 45°-90°, paper and wood boards exhibit significant depolarization, with an average degree of depolarization exceeding 0.5. This phenomenon may be closely related to their multi-scale rough structures and complex optical properties. In contrast, the degree of depolarization of artificial composite materials (such as epoxy carbon fiber, polyester carbon fiber, and plastic) is generally below 0.5, which may be attributed to the higher surface smoothness of artificial materials, resulting in relatively weaker optical field regulation capabilities. FIG. 4 shows the time-frequency spectrum of the synchronously measured micro-Doppler signal.

What is claimed is:

1. An experimental system for jointly and synchronously measuring laser micro-Doppler and polarization characteristics of space targets, comprising a light source module, a micro-Doppler-polarization module, and a host computer, wherein:
an emitted light from the light source module is split by a 1:9 fiber beam splitter for energy distribution, a local oscillator beam with a 10% power ratio is first modulated by an acousto-optic modulator with an 80 MHz fundamental frequency, and then equally distributed into four channels through a 1:1:1:1 fiber beam splitter, designated as local oscillator beam 1, local oscillator beam 2, local oscillator beam 3, and local oscillator beam 4;
the micro-Doppler-polarization module employs two polarization beam splitters to decouple the echo light into four linearly polarized beams with equal energy and polarization states of 0°, 90°, 45°, and 135°, respectively, designated as echo light 1, echo light 2, echo light 3, and echo light 4;
the micro-doppler-polarization module adopts a coherent detection architecture, and heterodyne mixing is performed on the four local oscillator beams and a corresponding echo light of the polarization state, respectively, after a photoelectric conversion is completed by photodetectors, a real-time signal acquisition is realized by a high-speed data acquisition card, and a collected signal is transmitted to the host computer by the high-speed data acquisition card;
the host computer calculates an energy corresponding to each polarization state after receiving four mixing signals, and then obtains a degree of depolarization of the target echo light. Meanwhile, four mixing signals are regarded as four laser micro-Doppler signals. Then, through digital filtering, time-frequency analysis and parameter calculation steps, the incident attitude angle of the target is obtained, and a synchronous real-time measurement of the micro-Doppler and polarization characteristics of the target is realized. On this basis, the degree of depolarization collected under different materials and various incident attitude angles are statistically analyzed, and the “incident attitude angle-degree of depolarization” mapping database is established, thereby realizing a joint application of micro-Doppler and polarization characteristics in the field of space target detection and recognition.

2. The experimental system for jointly and synchronously measuring laser micro-Doppler and polarization characteristics of space targets according to claim 1, wherein the light source module employs a fiber laser with a wavelength of 1064 nm, emits polarized light with a power of 100 mW, and a spot diameter is 2 cm after collimation.

3. The experimental system for jointly and synchronously measuring laser micro-Doppler and polarization characteristics of space targets according to claim 1, wherein the target comprises natural biological materials and artificial composite materials.

4. The experimental system for jointly and synchronously measuring laser micro-Doppler and polarization characteristics of space targets according to claim 3, wherein the natural biological materials are bird feathers, and the artificial composite materials are composite materials used for space targets, paper, or wood boards.

5. The experimental system for jointly and synchronously measuring laser micro-Doppler and polarization characteristics of space targets according to claim 1, wherein a degree of depolarization D is expressed as:
D=1−P
In a formula
$$P = \frac{\sqrt{{S}_{1}^{2} + {S}_{2}^{2}}}{{S}_{0}} ,$$
P is a degree of polarization, S₀ is a total intensity of light wave, S₁ is an intensity difference between linearly polarized beams in x and y directions, and S₂ is an intensity difference between linearly polarized beams in 45° and 135° directions.

6. The experimental system for jointly and synchronously measuring laser micro-Doppler and polarization characteristics of space targets according to claim 1, wherein an extraction formula of an incident attitude angle α is:
$$α = arcsin ( \frac{\vert {f}_{max} λ \vert}{4 \vert AB \vert π {f}_{s}} ) .$$
In the formula, |AB| is a distance from a vertex of a cube target to a center, |AB|=\sqrt{2}/2L, L is a side length of the cube target, fₘₐₓ is a maximum frequency shift of the micro-Doppler, λ is a wavelength of an emitted laser, and fₛ is a known spin frequency of the target.
